(19) United States
(12) Patent Application Publication
(10) Pub. No.: US 2013/0270048 A1
(43) Pub. Date: Oct. 17, 2013

(54) BRAKE CALLIPER FOR A VEHICLE BRAKE SYSTEM AND METHOD AND DEVICE FOR PRODUCING A BRAKE CALLIPER

(71) Applicant: Monika Schwarz, Tuttlingen (DE)

(72) Inventors: Guenther Schwarz, Tuttlingen (DE); Dieter Wiltsch, Brackenheim (DE)

(73) Assignee: Robert Bosch GmbH, Stuttgart (DE)

(21) Appl. No.: 13/519,779

(22) PCT Filed: Nov. 5, 2010
(86) PCT No.: PCT/EP2010/066891

§ 371 Date: Jan. 7, 2013

(30) Foreign Application Priority Data
Dec. 30, 2009 (DE) 10 2009 055 420.3

(51) Int. Cl. F16D 65/00; B22D 19/00

(52) U.S. Cl. CPC F16D 65/0075; B22D 19/00
USPC 188/73.31; 164/112; 164/334

(57) ABSTRACT

A brake calliper for a vehicle brake system includes a housing produced in the form of a casting. At least one guide structure configured to receive a corresponding brake piston is provided in the housing. A method and a device are configured to produce a casting having at least one guide structure. The at least one guide structure is formed in the housing by at least one prefabricated insert having a defined production quality, which is encapsulated by the casting material of the housing.

### PRIOR ART

The invention relates to a brake calliper for a vehicle brake system of the type specified in independent patent claim 1 and to a method for producing a casting of the type specified in independent patent claim 5, and to a device for producing a casting of the type specified in independent patent claim 8.

Known brake callipers for vehicle brake systems are generally produced as castings with rough guide structures for the brake pistons. These rough guide structures are then finished by means of appropriate machining or production processes in order to obtain a desired production quality for the guide structures. Since shrinkage cavities which form in the casting during the casting process have a negative effect on the introduction of the guide structures with the defined production quality, the reject rate can be considerable.

### DISCLOSURE OF THE INVENTION

In contrast, the brake calliper according to the invention for a vehicle brake system having the features of independent patent claim 1 has the advantage that the at least one guide structure in the housing produced as a casting is formed by at least one prefabricated insert with a defined production quality, which is encapsulated by the cast material of the housing. By means of the prefabricated insert, it is advantageously possible to embody the guide structure with a defined production quality independently of the casting process.

A method for producing a casting with at least one guide structure having the features of independent patent claim 6 has the advantage that the at least one guide structure with a defined production quality is introduced into the casting by means of at least one prefabricated insert, wherein the at least one insert is positioned in the casting tool using at least one positioning means. During the casting process, the remaining cavities within the casting tool are filled with a melt. After the casting process, the casting tool and the positioning means are removed, and the casting with the at least one guide structure with the defined production quality can be removed.

A device for producing a casting with at least one guide structure having the features of independent patent claim 8 has the advantage that at least one prefabricated insert for introducing the at least one guide structure with a defined production quality into the casting is positioned in the casting tool using at least one positioning means, wherein the remaining cavities within the casting tool can be filled with a melt during the casting process, and wherein, after the casting process, the at least one casting mold and the positioning means can be removed, and the casting with the at least one guide structure with the defined production quality can be removed.

The method according to the invention and the device according to the invention are preferably used to produce a brake calliper according to the invention.

By using prefabricated inserts, the desired production quality of the guide structure can advantageously be implemented in a simple and economical manner before the casting operation, without expensive and difficult finish machining of a rough structure. Moreover, embodiments of the invention advantageously allow an improvement in efficiency in the production of castings which have at least one guide structure with a defined production quality since the reject rate can be significantly reduced because shrinkage cavities in the casting which occur during the casting process cannot have a negative effect on the introduction of the at least one guide structure with the defined production quality. Moreover, the guide surfaces in the insert can be produced with greater smoothness and uniformity by virtue of prefabrication. Moreover, grooves for accommodating seals and fixing and/or protective collars can be introduced more easily and more quickly into the casting by means of the insert than is possible with difficult machining or production processes carried out after the casting process and involving complex tool shapes, such as angular milling heads.

Advantageous improvements of the brake calliper for a vehicle brake system, as specified in independent patent claim 1, of the method for producing a casting with at least one guide structure, as specified in independent patent claim 5, and of the device for producing a casting with at least one guide structure, as specified in independent patent claim 8, are possible by means of the measures and developments presented in the dependent claims.

It is particularly advantageous that the at least one prefabricated insert is embodied as a cylindrical bush and/or as a deep-drawn sleeve. The embodiment of the insert as a cylindrical bush is a particularly simple way of implementing the guide structure with the defined production quality. Moreover, the use of an open cylindrical bush instead of a blind hole makes it possible to simplify the handling and subsequent additional installation of components, such as the brake piston, piston seals etc., without direct access. Moreover, a groove for guiding or accommodating seals and/or fixing and/or protective collars can be arranged in a simple manner on the outside diameter of the cylindrical bush. For better positioning and/or fixing in the casting, the cylindrical bushes have raised portions and depressions in the form of grooves, slots etc. on the outer contours thereof. To produce the deep-drawn sleeve, the bottom of the sleeve is deep-drawn from a sheet-metal plate, and the sleeve stem is then punched out. The remaining sheet metal is folded twice, for example, and can be used as a projecting collar to guide or accommodate seals and/or fixing and/or protective collars. In addition, a brake line can be secured on the bottom of the insert prefabricated as a deep-drawn part, said brake line being connected to the cavity of the deep-drawn part. This advantageously makes it possible to eliminate the hydraulic sealing requirements on the cast housing since the brake fluid no longer comes into contact with the cast housing.

As a development of the brake calliper according to the invention, at least two guide structures are provided in the housing, being arranged coaxially with one another at a defined spacing in opposite housing parts of the housing. The guide structures are arranged opposite one another in pairs in order to achieve uniform loading of the brake disk during the braking operation.

As a development of the method according to the invention, the guide structure of the at least one prefabricated insert is produced with a final quality and is arranged with at least one casting core to form a composite in such a way that all the guide surfaces of the at least one insert which are produced with the final quality are covered by the at least one casting core. As a result, the guide surfaces produced with the final quality are advantageously protected from the melt during the casting process.

As a further development of the method according to the invention, the at least one casting core is positioned and fixed on a core support shaft connected to the casting tool, wherein, to produce a casting with two guide structures arranged coaxially opposite one another, a first composite, consisting of a first prefabricated insert and a first casting core, and a second composite, consisting of a second prefabricated insert and a second casting core, are positioned and fixed on the core support shaft. This advantageously allows simple and rapid positioning of the prefabricated inserts, making possible very precise coaxial arrangement of the oppositely situated guide structures in order to achieve uniform loading of the brake disk during the braking operation in use of the brakes as intended.

As a development of the device according to the invention, the at least one prefabricated insert is produced with a final quality and forms a composite with at least one casting core, which covers all the guide surfaces of the insert in order advantageously to protect the guide surface produced with the final quality from the melt during the casting process. The at least one casting core is, for example, positioned and fixed on a guide shaft, which is fixed at both ends in a first casting mold of the casting tool. By means of the fixing at both ends, it is advantageously possible to prevent a shift in position during the casting process. To produce a casting with two guide structures arranged coaxially opposite one another, a first composite, consisting of a first prefabricated insert and a first casting core, and a second composite, consisting of a second prefabricated insert and a second casting core, are positioned and fixed on the core support shaft. In this case, the core support shaft has at least two different outside diameters, which correspond to different inside diameters of the casting cores, wherein, first of all, the first casting core having the larger inside diameter is pushed onto the core support shaft and fixed axially on the core support shaft with first fixing means, and the second casting core having the smaller inside diameter is pushed onto the core support shaft until it abuts an offset at the transition between the different outside diameters, and is fixed on the core support shaft with second fixing means. The use of different diameters facilitates the axial positioning and fixing of the casting cores by virtue of the offsets which are formed.

Advantageous embodiments of the invention are illustrated in the drawings and are described below.

### BRIEF DESCRIPTION OF THE DRAWINGS

FIG. 1 shows a schematic sectional representation of a casting tool with a first illustrative embodiment of a brake calliper housing which is to be cast.

FIG. 2 shows a schematic sectional representation of a detail of a second illustrative embodiment of a brake calliper housing which is to be cast.

### EMBODIMENTS OF THE INVENTION

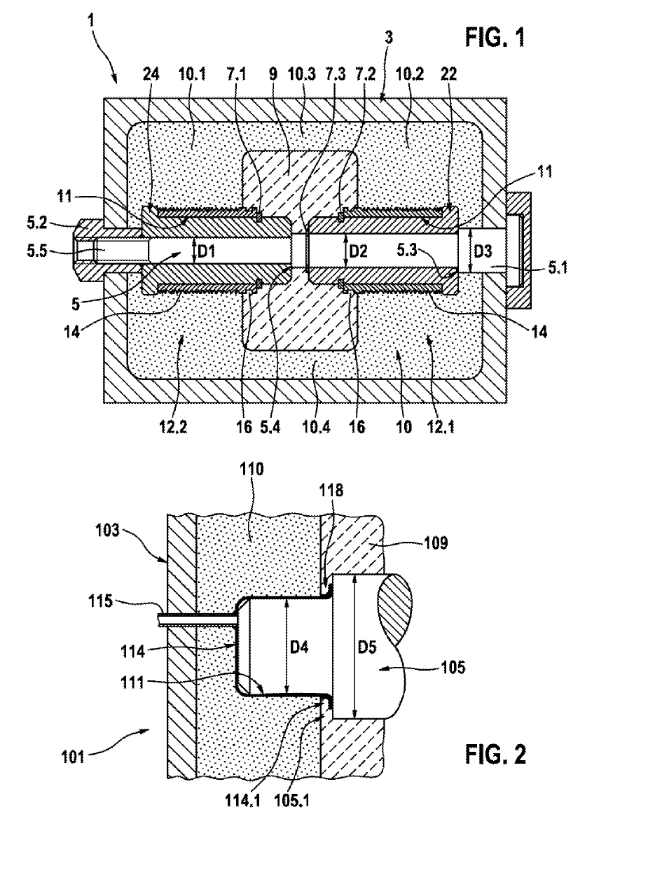

As can be seen from FIG. 1, a device for producing a brake calliper, which comprises a cast housing 10 with two guide structures 11 for accommodating corresponding brake pistons. The device comprises a casting tool 1, which comprises a plurality of casting molds, of which a downwardly open lower casting mold 3 for determining outer contours of the cast housing 10 of the brake calliper is visible. An outer contour casting core 9 for further determining outer contours of the cast housing 10 of the brake calliper is arranged within the lower casting mold 3.

As can furthermore be seen from FIG. 1, the housing 10 of the illustrated first illustrative embodiment of the brake calliper according to the invention for a vehicle brake system has two mutually opposite housing parts 10.1, 10.2, which are connected to one another by webs 10.3, 10.4 and in each of which a guide structure 11 for accommodating a corresponding brake piston is provided. According to the invention, a prefabricated insert 14 in each case forms the guide structure with a defined production quality 11 in the housing 10, wherein the prefabricated inserts 14 are encapsulated by the cast material of the housing 10. In the first illustrative embodiment shown, the prefabricated inserts 14 are each embodied as cylindrical bushes 14, on the outer contour of which raised portions and depressions in the form of grooves, slots etc. are arranged for better positioning and/or fixing in the cast housing 10. Moreover, a groove 16 for guiding and accommodating seals and/or fixing and/or protective collars is arranged in that part of the cylindrical bush which projects beyond the cast housing 10. The prefabricated inserts 14 for the introduction of the guide structures with a defined production quality into the casting 10 are positioned in the casting tool 1 using at least one positioning means. In the illustrative embodiment shown, these positioning means comprise two cylindrical casting cores 22, 24, which, with an insert 14 embodied as a sleeve, each form a composite embodied in such a way that all the guide surfaces 11 of the respective insert 14 are covered by the corresponding casting core 22, 24. In this arrangement, a first prefabricated insert 14 and a first casting core 22 form a first composite 12.1, and a second prefabricated insert 14 and a second casting core 24 form a second composite 12.2. The respective prefabricated insert 14 is pushed onto the respective casting core 22, 24 until it abuts a projecting edge, and it is fixed axially by corresponding fixing means 7.1, 7.2, which are embodied as circlips, for example.

As can furthermore be seen from FIG. 1, the casting cores 22, 24 are positioned and fixed with the prefabricated inserts 14 on a core support shaft 5, which is fixed at both ends in the first casting mold 3 of the casting tool 1. At one end, the core support shaft 5 is fixed axially in a corresponding receptacle in the first casting mold 3 by means of a head piece 5.1. At the other end, the core support shaft 5 has a thread 5.5, onto which a fastening nut 5.2 is screwed, which simultaneously fixes the second casting core 24 axially on the core support shaft 5. By means of the fastening nut 5.2, it is advantageously possible to compensate for axial tolerances. As an alternative, a head piece can be provided on this end too. In the illustrative embodiment shown, the core support shaft 5 has three different outside diameters D1, D2, D3. In this case, a first outside diameter D1 corresponds to an inside diameter D1 of the second casting core 24, a second outside diameter D2 corresponds to an inside diameter D2 of the first casting core 22, and a third outside diameter D3 corresponds to a corresponding opening in the first casting mold 3.

As can furthermore be seen from FIG. 1, the first casting core 22 having the larger inside diameter D2 is pushed onto the core support shaft 5 until it abuts a first offset 5.3, which is formed at the transition between the second and third outside diameters D2 and D3, and is fixed axially on the core support shaft 5 with a second fixing means 7.3, wherein the second fixing means can likewise be embodied as a circlip. The second casting core 24 having the smaller inside diameter D1 is pushed onto the core support shaft 5 until it abuts a second offset 5.4 at the transition between the first and second outside diameters D1 and D2, and is fixed axially on the core support shaft 5 using the fastening nut. Arranged between the two housing parts 10.1, 10.2 and the two webs 10.3, 10.4, within the lower casting mold 3, is the outer contour casting core 9 for further determining outer contours of the cast housing 10 of the brake calliper.

To produce the cast housing 10, the remaining cavities within the casting tool 1 are filled with a melt during the casting process, wherein, after the casting process, the casting mold 3, the outer contour casting core 9, the two casting cores 22, 24 and the core support shaft 5 are removed, allowing the casting 10 with the two guide structures 11 with a defined production quality to be removed.

As can be seen from FIG. 2, a prefabricated insert is embodied as a deep-drawn sleeve 114 in the second illustrative embodiment shown. To produce the deep-drawn sleeve 114, the bottom of the sleeve is deep-drawn from a sheet-metal plate, and the sleeve stem is then punched out. The remaining sheet metal is folded twice, for example, in order to produce a projecting collar 114.1. A receiving gap 118 for guiding and accommodating seals and/or fixing and/or protective collars is formed between the projecting collar 114.1 and the cast housing 110 of the brake calliper. The prefabricated insert 114 embodied as a deep-drawn sleeve for introducing the guide structures with a defined production quality into the cast housing part 110 is positioned in a casting mold 103 of the casting tool 101 using at least one positioning means. In the second illustrative embodiment shown, these positioning means comprise a cylindrical casting core 105 having two different outside diameters D4, D5, wherein a smaller outside diameter D4 is matched to the inside diameter of the insert 114, and wherein the projecting collar 114.1 of the insert 114 rests against the offset 105.1 between the smaller and larger outside diameters D4 and D5. Here too, the casting core 105 covers the guide surfaces 111 of the insert 114 in order to protect them from the ingress of melt during the casting process.

As can furthermore be seen from FIG. 2, a brake line is additionally secured, by welding for example, on the bottom of the insert 114 prefabricated as a deep-drawn part, said brake line being connected to the cavity of the deep-drawn part 114. This advantageously makes it possible to eliminate the hydraulic sealing requirements on the cast housing 110 since the brake fluid no longer comes into contact with the cast housing 110.

In embodiments of the invention, the desired production quality of the guide structure in a casting can advantageously be implemented in a simple and economical manner before the casting operation, without expensive and difficult finish machining of a rough structure. Moreover, embodiments of the invention advantageously allow an improvement in efficiency in the production of castings which have at least one guide structure with a defined production quality since the reject rate can be significantly reduced.

1. A brake calliper for a vehicle brake system, comprising:
a housing produced as a casting, and
at least one guide structure provided in the housing, the at least one guide structure being configured to accommodate a corresponding brake piston,
wherein the at least one guide structure in the housing is formed by at least one prefabricated insert with a defined production quality, the at least one prefabricated insert being encapsulated by the cast material of the housing.

2. The brake calliper as claimed in claim 1, wherein the at least one prefabricated insert is configured as one or more of a cylindrical bush and a deep-drawn sleeve.

3. The brake calliper as claimed in claim 2, wherein a brake line is secured on the bottom of the insert prefabricated as a deep-drawn sleeve, said brake line being connected to a cavity of the deep-drawn sleeve.

4. The brake calliper as claimed in claim 1, wherein at least two guide structures are provided in the housing, the at least two guide structures being arranged coaxially with one another at a defined spacing in opposite housing parts of the housing.

5. A method for producing a casting with at least one guide structure, comprising:
introducing at least one guide structure with a defined production quality into a casting by way of at least one prefabricated insert,
positioning the at least one insert in a casting tool using at least one positioning mechanism,
filling the remaining cavities within the casting tool with a melt during the casting process,
removing the casting tool and the positioning mechanism after the casting process, and
removing the casting with the at least one guide structure with the defined production quality.

6. The method as claimed in claim 5, wherein the guide structure of the at least one prefabricated insert is produced with a final quality and is arranged with at least one casting core to form a composite in such a way that all the guide surfaces of the at least one insert which are produced with the final quality are covered by the at least one casting core.

7. The method as claimed in claim 6, wherein the at least one casting core is positioned and fixed on a core support shaft connected to the casting tool, and wherein, to produce a casting with two guide structures arranged coaxially opposite one another, a first composite including a first prefabricated insert and a first casting core, and a second composite including a second prefabricated insert and a second casting core, are positioned and fixed on the core support shaft.

8. A device for producing a casting which has at least one guide structure 4, comprising:
a casting tool having at least one casting mold for configured to determine external contours of the casting, and
at least one prefabricated insert configured to introduce the at least one guide structure with a defined production quality into the casting, the at least one prefabricated insert being positioned in the casting tool using at least one positioning mechanism,
wherein remaining cavities within the casting tool are configured to be filled with a melt during the casting process,
wherein the at least one casting mold and the positioning mechanism are configured to be removed after the casting process, and
wherein the casting with the at least one guide structure with the defined production quality is configured to be removed.

9. The device as claimed in claim 8, wherein the at least one prefabricated insert is produced with a final quality and forms a composite with at least one casting core that covers all the guide surfaces of the inserts, and wherein the at least one casting core is positioned and fixed on a guide shaft that is fixed at both ends in a first casting mold of the casting tool.

10. The device as claimed in claim 9, wherein, to produce a casting with two guide structures arranged coaxially opposite one another, a first composite including a first prefabricated insert and a first casting core, and a second composite including a second prefabricated insert and a second casting core, are positioned and fixed on the core support shaft, wherein the core support shaft has at least two different outside diameters corresponding to different inside diameters of the casting cores, and wherein the first casting core having the larger inside diameter is pushed onto the core support shaft and fixed axially on the core support shaft with a first fixing mechanism, and the second casting core having the smaller inside diameter is pushed onto the core support shaft until it abuts an offset at the transition between the different outside diameters, and is fixed on the core support shaft with a second fixing mechanism.

11. The method as claimed in claim 5, wherein the casting having the at least one guide structure is a brake calliper, the brake calliper including:
a housing produced as a casting, and
at least one guide structure provided in the housing, the at least one guide structure being configured to accommodate a corresponding brake piston,
wherein the at least one guide structure in the housing is formed by at least one prefabricated insert with a defined production quality, the at least one prefabricated insert being encapsulated by the cast material of the housing.

12. The device as claimed in claim 8, wherein the casting having the at least one guide structure is a brake calliper, the brake calliper including:
a housing produced as a casting, and
at least one guide structure provided in the housing, the at least one guide structure being configured to accommodate a corresponding brake piston,
wherein the at least one guide structure in the housing is formed by at least one prefabricated insert with a defined production quality, the at least one prefabricated insert being encapsulated by the cast material of the housing.
